(19) United States
(12) Patent Application Publication
(10) Pub. No.: US 2025/0042731 A1
(43) Pub. Date: Feb. 6, 2025

(54) Device for producing hydrogen by gaz pyrolysis

(71) Applicant: E.T.I.A. - EVALUATION TECHNOLOGIQUE, INGENIERIE ET APPLICATIONS, COMPIEGNE CEDEX (FR)

(72) Inventors: Olivier LEPEZ, SAINT-CYR-SUR-MER (FR); Philippe SAJET, LACROIX-SAINT-OUEN (FR)

(21) Appl. No.: 18/715,586

(22) PCT Filed: Dec. 1, 2022
(86) PCT No.: PCT/EP2022/084132

§ 371 Date: May 31, 2024

(30) Foreign Application Priority Data
Dec. 3, 2021 (FR) 2112955

(51) Int. Cl. C01B 3/24; B01D 45/16; B01D 53/047; B01J 6/00; C01B 3/56

(52) U.S. Cl. CPC C01B 3/24; B01D 45/16; B01D 53/047; B01J 6/008; C01B 3/56; B01D 2256/16; C01B 2203/0272; C01B 2203/042; C01B 2203/085; C01B 2203/1241

(57) ABSTRACT

Machine for producing dihydrogen by pyrolysis of a gas (G) comprising:
a. a reactor comprising at least one tube (2), at least partially made of electrically conductive material, shaped in a spiral with a first end (2a) forming an inlet for a gas and an opposite second end (2b) forming an outlet for the gas,
b. a power supply circuit (3) connected to the tube (2) in order to heat the tube by Joule heating to a temperature above a pyrolysis temperature of the gas (G) circulating in the tube (2),
c. at the second end of the tube (2b), a member (4) for separating the gas leaving the tube (Gp) and the solid particles(S) present in the gas (Gp),
d. means (5) for collecting the solid particles(S), and
e. a device (6) for treating the gas after passing through the separating member (4).

The present invention relates to the field of producing dihydrogen (H₂) by pyrolysis of a pure gas or a gaseous mixture.

### BACKGROUND OF THE INVENTION

Dihydrogen, or more commonly called hydrogen molecule or simply hydrogen consists of two hydrogen atoms.

Hydrogen is commonly used in the industry for manufacturing chemical fertilizers or in the oil industry, but also as energy. The fight against global warming and using carbon-free energy has strengthened research and development on using hydrogen as energy, in particular for motorisation of heavy vehicles (lorries, buses, trains, aeroplanes, etc.). Thus, it is estimated that global hydrogen needs, all sectors combined, will go from 71 million tonnes in 2019 to almost 137 million tonnes by 2040, and to 519 million tonnes in 2070, with a use mainly in transport and aviation (more than 50%), in the industry (around 15%) and electricity production (around 15%).

To meet this demand, it is therefore essential to increase global hydrogen production capacities. Currently, 45 million tonnes of hydrogen are produced a year, mainly from fossil raw materials such as oil, coal or gas, by gasifying coal or steam reforming of natural gas. These two methods emit a great quantity of polluting or greenhouse gases such as CO or CO₂.

It is also possible to produce hydrogen by water electrolysis, but this assumes water is consumed, which is not always possible. Biological methods for producing hydrogen are also undergoing development, they have even lower yields and also produce CO₂.

Another method known as “Kvaerner Carbon Black & Hydrogen” makes it possible to produce hydrogen and carbon from hydrocarbons by high-temperature thermal cracking. The quantity of heat necessary to produce thermal cracking is provided by a recycled hydrogen-based plasma burner coming from said method which cuts off the quantity of hydrogen obtained and makes a method which consumes a lot of energy with a hydrogen yield which is ineffective.

Furthermore, hydrogen is often produced in large units requiring its transport from said units to the final location of use over sometimes long distances, also increasing the environment cost of producing hydrogen.

Thus, it is necessary to develop more effective, less polluting and less energy-consuming methods, local dihydrogen production units should also be proposed, which are easy to implement and to size, according to the quantity of dihydrogen to be produced.

### AIM OF THE INVENTION

The invention aims, in particular, to propose a machine for producing dihydrogen by pyrolysis of a gas, in particular, a hydrocarbon gas, which is easy to install locally, that can be sized according to the quantity of dihydrogen to be produced, the invention also proposes an integrated installation for producing dihydrogen, as well as a method for producing dihydrogen by pyrolysis of a gas, in particular of a hydrocarbon gas, said production being able to be done locally, being more effective, less energy-consuming and less polluting than current production methods.

### SUMMARY OF THE INVENTION

To this end, a machine for producing dihydrogen by pyrolysis of a gas is provided, according to the invention, comprising:
a. a reactor comprising at least one tube, at least partially made of electrically conductive material, shaped in a spiral with a first end forming an inlet for a gas and an opposite second end forming an outlet for the gas,
b. a power supply circuit connected to the tube in order to heat the tube by Joule heating to a temperature above a pyrolysis temperature of the gas circulating in the tube,
c. at the second end of the tube, a member for separating the gas leaving the tube and the solid particles present in the gas,
d. means for collecting the solid particles,
e. a device for treating the gas after passing through the separating member.

The machine according to the invention is particularly suitable for treating a hydrocarbon gas, in which the solid particles recovered by the collecting means are mainly carbon and the gas leaving the treating device is mainly dihydrogen.

According to the particular features of the invention, which can be used individually or in combination:
the reactor of the machine comprises a tube, the diameter, the deployed length, the bending diameter and the number of turns of which are defined according to the nature and the pyrolysis temperature of the gas to be treated, according to the transit time and the minimum speed of the gas to be treated in the reactor and according to the ratio between the quantity of electrical energy necessary to heat the tube by Joule heating and the chemical energy necessary for the pyrolysis reaction;
the tube is housed in airtight box filled with high temperature-resistant insulating balls;
the power supply circuit of said machine preferably comprises at least one engine or one gas turbine;
the member for separating the carbon particles generated by pyrolysis consists of at least one cyclone;
the device for treating the pyrolysed gas comprises at least one pressure inversion adsorption device, making it possible to purify the dihydrogen;
a preheating device is mounted upstream of the tube to preheat the gas prior to it entering the tube.

The invention also relates to an integrated installation for producing dihydrogen by pyrolysis of a hydrocarbon gas, comprising:
(a) a gas circulation device connected directly to the gas source,
(b) a gas preheating device,
(c) a reactor comprising at least one tube section, at least partially made of electrically conductive material, shaped in a spiral with a first end forming an inlet for the gas and an opposite second end forming an outlet for the gas,
(d) a power supply circuit connected to the tube in order to heat the tube by Joule heating to a temperature above a pyrolysis temperature of the gas circulating in the tube, comprising at least one engine or one gas turbine,
(e) a member for cooling/separating the pyrolysed gas leaving the tube, on the one hand, and the solid particles present in said pyrolysed gas, on the other hand
(f) a device for collecting the solid particles,
(g) a device for treating the pyrolysed gas for separating, in the pyrolysed gas, the dihydrogen from the residual gases, the dihydrogen being pressurised and the residual gases being used to power the engine or the gas turbine of the power supply circuit.

Preferably, the integrated installation is sized according to the quantity of hydrogen to be produced. Thus, if needed, the reactor comprises a tube section array connected in pairs in series and extending parallel to one another and facing one another, each section, being shaped in a spiral with a diameter of between 25 and 250 mm, a deployed length of between 20 m and 150 m, a bending diameter of between 100 mm and 3000 mm. The respective dimensions of the tube sections, as well as the number of sections are suitable according to the quantity of hydrogen to be produced.

More preferably, the device for treating the integrated installation comprises at least one pressure swing adsorption device.

The invention also relates to a method for producing dihydrogen from hydrocarbon gas comprising the steps of:
a. preheating the gas to be treated;
b. injecting the preheated gas to be treated into a machine or an installation according to the invention comprising at least one tube or at least one current passage tube section shaped in a spiral, the number and the configuration of the tube or current passage tube section being sized according to the nature and the pyrolysis temperature of the gas to be treated and according to the ratio between the quantity of electrical energy necessary to heat the tube or tube section by Joule heating and the chemical energy necessary for the pyrolysis reaction;
c. downstream of the tube or tube section, cooling the pyrolysed gas leaving the tube or the tube section and separating the solid particles present in said pyrolysed gas from said pyrolysed gas;
d. collecting the solid particles;
e. treating the gas by pressure swing adsorption to separate the dihydrogen in the gas from the residual gases;
f. conditioning the dihydrogen.

Other features and advantages of the invention appear on reading the following description of a particular and non-limiting embodiment of the invention.

### BRIEF DESCRIPTION OF THE DRAWINGS

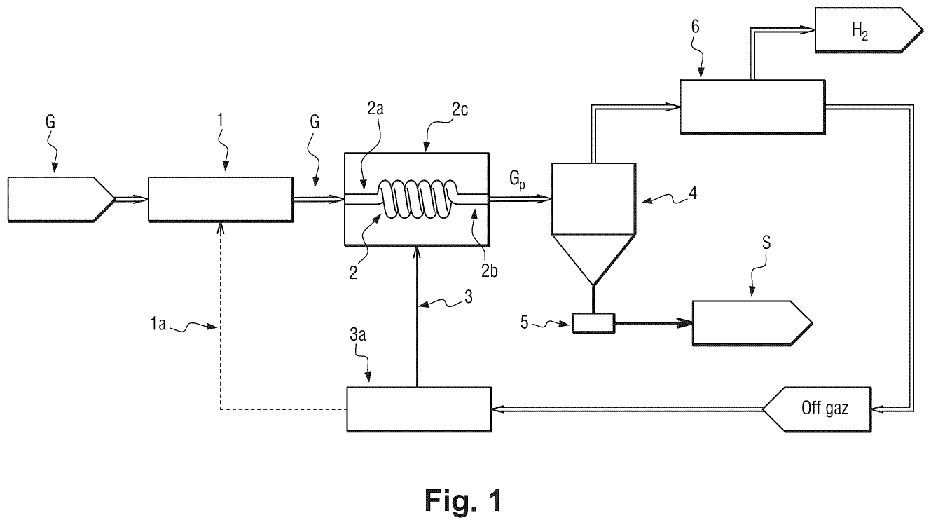

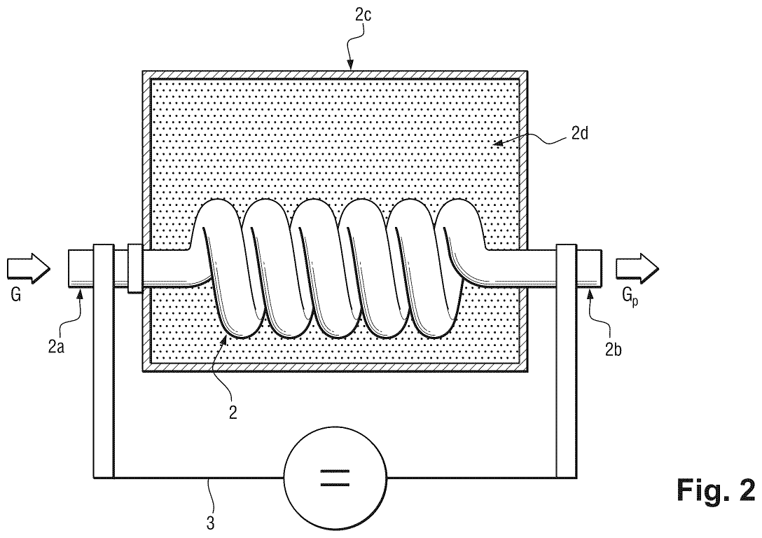

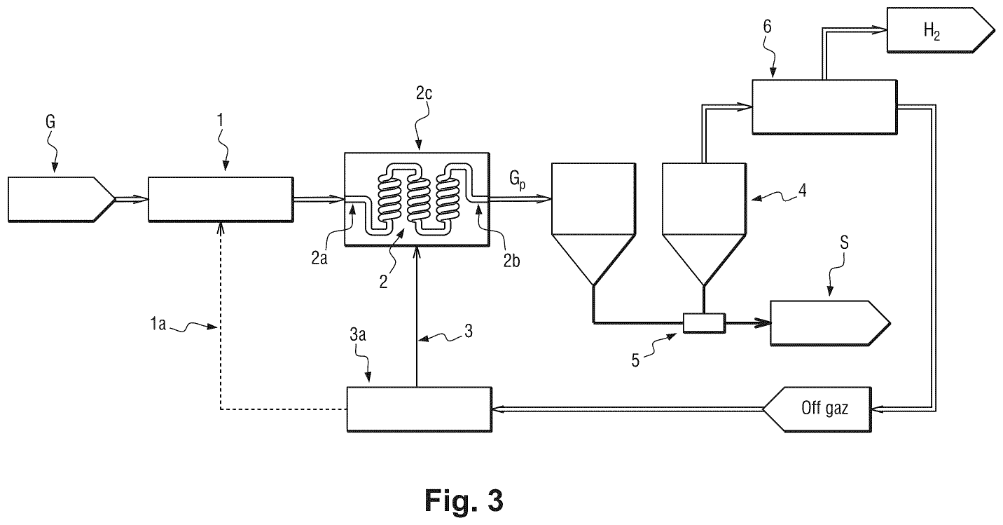

Reference is made to the accompanying drawings, among which:

[FIG. 1]: diagram of a machine according to the invention where the double arrow represents the circulation of the gas, the bold arrow represents the recovery of the solid particles, the single line arrow represents the power supply and the dotted arrow represents the heat exchanger.

[FIG. 2]: schematic diagram of the reactor

[FIG. 3]: diagram of an installation comprising an in-series tube section battery.

### DETAILED DESCRIPTION OF THE INVENTION

According to a preferable embodiment of the invention and in reference to FIGS. 1 and 2, the machine for producing dihydrogen by pyrolysis of a gas G comprises a reactor comprising at least one tube 2.

The tube 2 is, in this case, entirely made of electrically conductive material and is shaped in a spiral with a first end 2a forming an inlet for a gas G and an opposite second end 2b forming an outlet for the pyrolysed gas Gp.

A power supply circuit 3 is connected to the tube 2 in order to heat the tube by Joule heating to a temperature above a pyrolysis temperature of the gas circulating in the tube. It is reminded that the pyrolysis of the gas is a chemical breakdown of said gas under the effect of the temperature and in the total absence of oxygen. The power supply circuit 3 comprises, in this case, a current generator 3a. A person skilled in the art will know how to size the generator to obtain the electrical power necessary for the heating by Joule heating of the tube 2 for the pyrolysis of the gas to be treated. Generally, the tube is powered by a low-voltage, but high-intensity electrical current. The generator can deliver a direct or alternating current. The power supply circuit 3 can be connected to an electrical distribution network, to batteries or to an electricity generator (as examples, these can be solar panels, wind turbines or a powered generator). Naturally, there can be multiple power supply sources. According to a favoured embodiment of the invention, the current is at least partially generated by an engine or a gas turbine 3a. The electrical power necessary is calculated according to the temperature to be reached in the tube such that the gas G is pyrolysed. As an example, the adjustment of the temperature can be controlled by a thyristor, subject to the temperature of the gas Gp at the second end 2b of the tube 2 which makes it possible to control the voltage and/or the intensity of the current sent into the tube 2, the adjustment is done equally by wave train or by phase angle.

At the second end of the tube 2b, a member 4 for cooling and for separating the gas Gp leaving the tube 2 is connected, intended on the one hand, to cool the gas Gp and on the other hand, to separate the pyrolysed gas Gp and the solid particles present in said pyrolysed gas. The cooling and separating member 4, in this case, consists of at least one cyclone. A person skilled in the art will know how to size the number and the size of the cyclones, according to the volume of pyrolysed gas to be cooled and to be separated.

A collecting means 5 is associated with the separating member 4 to collect the solid particles S extracted from the pyrolysed gas Gp. The collecting means is of the tray or airtight conveyor type. If a person skilled in the art deems it necessary, they can add to the collecting means 5, complementary devices for separating the finest carbon particles (for example, these could be bag filters, ceramic filters, etc.).

A treating device 6 is connected to the cooling and separating member 4 to treat the pyrolysed gas Gp after it has passed into the cooling and separating member 4. The treating device is, in this case, a pressure swing adsorption (PSA) device.

In the embodiment described in this case, the gas G to be treated is a hydrocarbon gas and more specifically methane of chemical formula CH₄.

The pyrolysis reaction of methane CH₄ is done according to the following reaction:

CH₄->2H₂+C

The pyrolysis temperature of methane is well-known to a person skilled in the art, and is between 1000° C. and 1100° C. and makes it possible to produce, on the one hand, carbon which constitute solid particles S, recovered by the collecting means 5 of the machine which is the subject matter of the invention and, on the other hand, mainly dihydrogen H₂ after passing through the treating device 6 of the machine which is the subject matter of the invention.

Pyrolysis is, in this case, performed in the tube 2 which constitutes a current passage tube, as is more specifically illustrated in FIG. 2. The principle is known in itself and consists of energizing the tube 2 by means of the power supply circuit 3 and circulating the gas G to be pyrolysed in the tube. The passing of an electrical current through the electrically conductive material constituting the tube 2 produces heat by Joule heating. The heat is transmitted from the tube 2 to the gas G by convection via the internal wall of the tube, which is in contact with the gas G and forms the exchange surface. Thus, the electrical energy supplied by the current generator, transmitted by the supply circuit 3 is transformed into thermal energy by the tube 2 then into chemical energy necessary for the pyrolysis reaction of the gas G.

Naturally, the tube 2 must be made of an electrically and thermally conductive, and high temperature-resistant material. Preferably, the tube 2 is made of metal alloy (for example, of Inconel), of tantalum, of steel of reference 602 CA, of molybdenum or any other heat-resistant steel which can be used at a very high temperature (i.e. at more than 1200° C.).

Further to its conduction and high temperature-resistance capacities, the tube 2 must be shaped, such that the exchange surface between the tube 2 and the gas to be pyrolysed is as large as possible.

Thus, the inventors have determined that the optimal configuration of the tube 2 is a tube which is helically wound about a longitudinal axis to form a spiral with a diameter, a deployed length, a bending diameter and a number of turns defined according to the nature and the pyrolysis temperature of the gas to be treated, according to the transit time and the minimum speed of the gas to be treated in the reactor and according to the ratio between the quantity of electrical energy necessary to heat the tube 2 by Joule heating and the chemical energy necessary for the pyrolysis reaction.

The diameter of the tube 2 must be reduced as much as possible to guarantee a high convective exchange coefficient between the gas to be treated and the internal surface of the tube. The exchange coefficient is better when the circulation speed of the gas to be treated is high. Thus, the inventors have established that the diameter of the tube 2 is defined so as to obtain a propagation speed of the gas to be treated in the reactor of at least 15 m/s to 20 m/s. Such a speed enables the driving of solid particles through gas streams during the process of the pyrolysis reaction, by thus avoiding the deposition of carbon particles on the inner surface of the tube. Such a speed also enables an optimal adjustment for a cyclonic separation of the particles S in the cooling/separating member 4 at the reactor outlet. The reduced diameter of the tube 2 imposes a long length of the tube 2 to guarantee a sufficient exchange surface to transmit the total thermal power necessary to achieve the desired heating of the gas to the pyrolysis temperature, and also to absorb the transformation energy from the methane into dihydrogen. The helical shaping of the tube 2 therefore makes it possible to combine a diameter as narrow as possible with a long deployed length for a size which is as limited as possible.

Preferably and as particularly illustrated in FIG. 2, the reactor comprises a tube 2 housed in an airtight box 2c filled with high temperature-resistant thermal insulating balls 2d. Insulation in the form of balls enables the expansion of the tube 2 under the effect of heat, while preserving the insulating capacities of the box 2c and the outer dimensions of the reactor. As an example, the box 2c can have an outer wall formed of a steel sheet and an inner wall formed of a thermally insulating concrete layer. The thermal insulating balls used can be high temperature-resistant vermiculite or ceramic balls. A person skilled in the art will know how to use, at the inlet and at the outlet of the box 2c and of the tube 2, any system enabling the circulation of gas and the adjustment of the flow rate, while avoiding leakages, for example, a pump. The thermal and electrical sealing between the tube 2 and the box 2c can be achieved by means of electrically insulated seals and expansion sections.

Thus, the hydrocarbon gas G enters into the reactor, circulates in the tube 2 in which it is pyrolysed and, leaving the reactor, the pyrolysed gas Gp is sent into the separating member 4 which cools and separates the solid particles S from the pyrolysed gas Gp. Yet, as already mentioned, the chemical reaction of pyrolysis of the gas G produces solid carbon particles S and pyrolysed gas Gp, which makes it necessary to separate the solid particles S and the pyrolysed gas Gp. The passing of the pyrolysed gas through the cyclone of the separating member 4 makes it possible to cool and separate, on the one hand, the solid particles S, mainly consisting of carbon, which will be collected in the collecting means 5 and, on the other hand, the pyrolysed gas Gp. The heavier solid carbon particles S will, under the effect of gravity and the cyclonic effect, be separated from the pyrolysed gas Gp and fall into the collecting means 5. The carbon particles thus collected can be valuated in the industry as carbon black, in particular, the tyre industry, water treatment, plastics processing, or the automotive industry.

Furthermore, the pyrolysed gas Gp obtained at the outlet of the reactor is a gaseous mixture consisting of dihydrogen (H₂) and non-pyrolysed or poorly pyrolysed residual gases (otherwise called off-gases), that is why, it is necessary that pyrolysed gas Gp is treated through the treating device, in order to separate the dihydrogen H₂ from the off-gases. During its passing through the cooling/separating member 4, the pyrolysed gas Gp is also cooled to return to a temperature close to the ambient temperature, before being sent into the treating device 6 intended to separate the dihydrogen from the other residual gases.

At the machine outlet, the user therefore collects carbon and dihydrogen, dihydrogen that they can then condition for a later use.

They also recover residual gases. In order to improve the environmental and energy performance of the machine, the residual gases are preferably recovered at the outlet of the treating device to power the engine or the gas turbine 3a which generates some of the current necessary for powering the reactor. If necessary, the off-gases can be reinjected into the machine to follow a new complete treating cycle.

In the preferred embodiment of the invention, the machine comprises, upstream of the reactor, a gas G preheating device. This preheating device 1 preferably comprises a heat exchanger 1a comprising a “cold” circuit in which the gas G circulates and a “hot” circuit la in which a heat-transfer fluid circulates. Preferably, the heat-transfer fluid can be constituted by the exhaust gas of the gas engine of the power supply circuit 2. Such an arrangement is particularly interesting during the start-up of the machine, in order to optimise the pyrolysis reaction in the tube 2. Moreover, the energy recovered during the passing of the treated gas through the separating and cooling member(s) can also be directed to the heat exchanger 1a. Indeed, the higher the temperature of the gas G entering into the tube 2 is, the quicker the gas G will reach the pyrolysis temperature in the tube 2, the quicker the pyrolysis reaction along the tube will occur, and the better the yield of the reaction will be. The gas to be treated will preferably be preheated to reach a temperature of around 100 to 300° C.

In an integrated installation for producing hydrogen, according to the invention, the integrated installation has an inlet directly connected to a gas source to be treated, in this case, methane. A person skilled in the art will know how to use the connections, valves, and pipes suitable for the circulation of the gas to be treated and for the supply flow rate of the latter. The methane to be treated can come directly from a gas distribution network, of gas reservoir or biogas. A person skilled in the art will also know how to adapt the gas circulation parameters in the installation, according to the features of the gas, like pressure and the inlet temperature of the gas in the installation.

Thus, the installation according to the invention comprises:
a. a gas supply and circulation device 3, 3a connected directly to the gas source to be treated (not represented);
b. a gas preheating device 1, 1a;
c. a reactor comprising at least one section of tube 2, at least partially made of electrically conductive material, shaped in a spiral with a first end forming an inlet 2a for the gas and an opposite second end 2b forming an outlet for the gas;
d. a power supply circuit 3 connected to the tube 2 in order to heat the at least one tube section by Joule heating to a temperature above a pyrolysis temperature of the gas circulating in the tube, comprising at least one engine or one gas turbine 3a;
e. a member 4 for cooling/separating the pyrolysed gas Gp leaving the at least one tube 2 section, on the one hand, and the solid particles S present in the pyrolysed gas Gp, on the other hand;
f. a device 5 for collecting the solid particles S;
g. a device 6 for treating the pyrolysed gas Gp for separating, in said pyrolysed gas on the one hand, the dihydrogen (H₂) from the residual gases (off-gases), the dihydrogen being pressurised and the residual gases being used to power the engine or the gas turbine 3a of the power supply circuit 3.

Furthermore, the temperature of the gas to be treated can be controlled at any time, thanks to temperature sensors making it possible to finely control the preheating device 1, 1a and the electrical power necessary for the power supply of the tube 2. In particular, the installation can comprise residual gas distribution means according to which they undergo another treatment cycle, or that they are used to power the engine or the gas turbine 3a.

The installation can also comprise means for controlling the engine or the gas turbine according to the residual gases received, such that the current generated can correctly power the installation for an optimum operation.

In the particular embodiment illustrated by FIG. 3, the reactor of the integrated installation comprises a tube section array 2 connected in pairs in series, and extending parallel to one another and facing one another. This makes it possible to preserve a certain compactness in the installation. Each section is shaped in a spiral with a diameter advantageously between 25 and 250 mm, a deployed length of between 20 m and 150 m, a bending diameter of between 100 mm and 3000 mm. As above, the diameter of the tube sections is defined so as to obtain a propagation speed of the gas to be treated in the reactor of at least 15 m/s to 20 m/s to avoid the deposition of carbon particles on the inner surface of the tube sections. Preferentially, and so as to decrease the size of the tube sections in the installation, these can be arranged vertically. The separating device comprises, in this case, several cyclones to improve the yield of the installation.

Thus, the installation according to the invention is fully integrated and makes it possible to produce dihydrogen by pyrolysis from a hydrocarbon gas source, in particular from methane, locally and with a good energy and environmental performance: the installation can be sized, in particular concerning the number and the sizing of the tube sections according to the local dihydrogen production needs, the pyrolysis of methane does not produce CO₂, the carbon particles are enhanced in the industry and the residual gases are reinjected into the installation for its operation.

The two examples below have particular implementations of the invention.

Example 1: Sizing of the machine according to imposed inlet parameters and to the volume flow rate of the gas to be treated.

Hypothetically:
the gas to be treated in this case to produce hydrogen is methane.
The conversion yield of methane into dihydrogen is: 80%
The heat of the pyrolysis reaction is: 0.927 kWh/Nm³ of methane (Nm³: normal cubic metres per hour
the normal cubic meter is the unit for measuring the volume of a gas under normal temperature and pressure conditions)
The average specific heat of methane is: 2.25 KJ/kg/° C.
The safety factor applied to calculating the necessary power integrating heat losses is: 1.2
The yield of the electrical transformer is: 90%
The inlet temperature of methane in the machine is: 20° C.
The temperature of the tube when methane enters into the reactor of the machine is estimated at: 200° C.
The outlet setpoint temperature of the pyrolysed gas reactor is: 1100° C.
The average convective exchange coefficient between the internal wall of the tube and the gas to be treated is: 20 W/m²° C.
The minimum circulation speed of the gas to be treated in the tube is: 15 m/s

That is Qv, the volume flow rate of methane to be treated, expressed in Nm3/h, then the following estimated sizing elements are obtained:
Quantity of dihydrogen produced in kg/h:
   H2=0.144 Qv
Electrical power to be supplied to the device in kW:
   P=1.870 Qv
Exchange surface of the reactor in m²:
   S=0.6875 Qv
Inner diameter of the reaction tube in m:
   Di=(Qv*1.104E-4)\hat{ }0.5
Length of the reaction tube in m:
L=S/(π*Di)

Example 2: Configuration of the machine according to the invention for producing dihydrogen from methane, according to the following features:
flow rate of methane of 50 Nm³/h
temperature of methane at the inlet of the machine 20° C.

The inventors consider that the temperature to be obtained in the tube to perform the pyrolysis is around 1100° C. Indeed, the theoretical pyrolysis temperature of methane is between 1000° C. and 1100° C.

The required energy calculated to achieve the temperature increase and the pyrolysis of methane is 70 kW, by applying a 20% margin on this value to cover possible losses, the inventors consider that the energy required is 84 kW.

According to these parameters and according to a more precise calculation based on the general formulas presented above, the configuration of the tube 2 is as follows:
the inner diameter of the tube is 76 mm,
the length of the tube is 152 m,
the number of turns is 22,
the diameter of a turn is 2280 mm.

the power supply of the machine must be able to supply 84 kW, an electrical generator capable of supplying at least 94 kW should therefore be installed.

At the outlet, and considering a conversion yield of 80%, the machine produces:
dihydrogen H₂: 7.14 kg/hour;
carbon S: 21 kg/hour;
off-gas residual gases: 7.14 kg/hour.

The residual gases, if they are recycled to supply the gas engine of the machine, making it possible to supply between 40% and 50% of the electrical power necessary.

Naturally, at the machine outlet, it is necessary to provide a system for compressing hydrogen for an injection into a dedicated network, or to reach a pressure of 350 bars or 700 bars, pressure at which hydrogen is generally stored.

Such a dihydrogen production subject to a dihydrogen purity of 99.999% from methane could make it possible to supply vehicles.

Naturally, the invention is not limited to the embodiment described, but covers any variant coming within the scope of the invention such as defined by the claims.

In particular, the machine, the installation and the method of the invention partially apply to methane, but they can also apply to any hydrocarbon gas, such as butane, propane, etc., or any other synthesis gas obtained by methanisation, pyrolysis or gasification of biomasses or waste.

The reactor can equally be installed vertically or horizontally.

Although, in this case, one or more cyclones are used as a cooling and separating member, it is possible to use a cooling member to cool the pyrolysed gas, then at the outlet of the cooling member, send the cooled pyrolysed gas into a distinct separating member to separate the solid particles from the pyrolysed gas.

For example, although the treating device is, in this case, a pressure swing adsorption device. A person skilled in the art can use any other treating device making it possible to separate dihydrogen from off-gases.

The power supply circuit can mix different energy sources, for example, from among the following: electrical network, battery, solar panels, wind turbines, hydroelectricity, turbines, generator, etc.

Although the electrical power delivered to each tube section of the integrated installation is identical, it can also be different according to the tube sections, so as to finely manage the temperature profiles.

Although the tube sections of the installation are, in this case, mounted in series, they can also be mounted in parallel. A person skilled in the art will thus know how to adapt the inlet and the outlet of the gas to be treated.

1. A machine for producing dihydrogen by pyrolysis of a gas (G) comprising:
a. a reactor comprising at least one tube, at least partially made of electrically conductive material, shaped in a spiral with a first end forming an inlet for a gas and an opposite second end forming an outlet for the gas,
b. a power supply circuit connected to the tube in order to heat the tube by Joule heating to a temperature above a pyrolysis temperature of the gas circulating in the tube,
c. at the second end of the tube, a member for separating the gas leaving the tube and the solid particles present in the gas,
d. means for collecting the solid particles,
e. a device for treating the gas after passing through the separating member.

2. The machine according to claim 1, arranged to treat a hydrocarbon gas, wherein the solid particles recovered by the collecting means are mainly carbon and the gas leaving the treating device is mainly dihydrogen (H₂).

3. The machine according to claim 1, wherein the tube has a diameter, a deployed length, a bending diameter and a number of turns defined according to the nature and the pyrolysis temperature of the gas to be treated, according to the transit time and the minimum speed of the gas to be treated in the reactor and according to the ratio between the quantity of electrical energy necessary to heat the tube by Joule heating and the chemical energy necessary for the pyrolysis reaction.

4. The machine according to claim 1, wherein the reactor comprises at least one current passage tube housed in an airtight box filled with high-temperature insulating balls.

5. The machine according to claim 1, wherein the power supply circuit comprises at least one engine or one gas turbine.

6. The machine according to claim 1, wherein the separating member comprises at least one cyclone.

7. The machine according to claim 1, wherein the treating device comprises at least one pressure swing adsorption device.

8. The machine according to claim 1, comprising a preheating device mounted upstream of the tube to preheat the gas prior to it entering the tube.

9. An installation for producing dihydrogen by pyrolysis of a hydrocarbon gas, comprising:
a. a gas supply and circulation device connected directly to the gas source to be treated;
b. a gas preheating device;
c. a reactor comprising at least one section of a tube, at least partially made of electrically conductive material, shaped in a spiral with a first end forming an inlet for the gas and an opposite second end forming an outlet for the gas;
d. a power supply circuit connected to the tube in order to heat the at least one tube section by Joule heating to a temperature above a pyrolysis temperature of the gas circulating in the tube, comprising at least one engine or one gas turbine;
e. a member for cooling/separating the pyrolysed gas leaving the at least one tube section, on the one hand, and the solid particles present in the pyrolysed gas, on the other hand;
f. a device for collecting the solid particles;
g. a device for treating the pyrolysed gas for separating, in said pyrolysed gas on the one hand, the dihydrogen (H₂) from the residual gases (off-gases), the dihydrogen being pressurised and the residual gases being used to power the engine or the gas turbine of the power supply circuit.

10. The installation according to claim 9, wherein the reactor comprises a tube section array connected in pairs in series and extending parallel to one another and facing one another, each tube section being shaped in a spiral with a diameter of between 25 and 250 mm, a deployed length of between 20 m and 150 m, a bending diameter of between 100 mm and 3000 mm.

11. The installation according to claim 9, wherein a treating device comprises at least one pressure swing adsorption device.

12. A method for producing dihydrogen from hydrocarbon gas comprising the steps of:
a. preheating the gas to be treated;
b. injecting the preheated gas to be treated into the machine according to claim 1, comprising at least one tube or at least one current passage tube section shaped in a spiral, the number and the configuration of the tube or current passage tube section being sized according to the nature and the pyrolysis temperature of the gas to be treated and according to the ratio between the quantity of electrical energy necessary to heat the tube or tube section by Joule heating and the chemical energy necessary for the pyrolysis reaction;
c. downstream of the tube or tube section, cooling the pyrolysed gas leaving the tube or the tube section and separating the solid particles present in said pyrolysed gas from said pyrolysed gas;
d. collecting the solid particles;
e. treating the gas by pressure swing adsorption to separate the dihydrogen in the gas from the residual gases;
f. conditioning the dihydrogen.

13. A method for producing dihydrogen from hydrocarbon gas comprising the steps of:
a. preheating the gas to be treated;
b. injecting the preheated gas to be treated into the installation according to claim 9, comprising at least one tube or at least one current passage tube section shaped in a spiral, the number and the configuration of the tube or current passage tube section being sized according to the nature and the pyrolysis temperature of the gas to be treated and according to the ratio between the quantity of electrical energy necessary to heat the tube or tube section by Joule heating and the chemical energy necessary for the pyrolysis reaction;
c. downstream of the tube or tube section, cooling the pyrolysed gas leaving the tube or the tube section and separating the solid particles present in said pyrolysed gas from said pyrolysed gas;
d. collecting the solid particles;
e. treating the gas by pressure swing adsorption to separate the dihydrogen in the gas from the residual gases;
f. conditioning the dihydrogen.
